(19) United States
(12) Patent Application Publication
(10) Pub. No.: US 2016/0291518 A1
(43) Pub. Date: Oct. 6, 2016

(54) IMAGE FORMING APPARATUS

(71) Applicant: KYOCERA Document Solutions Inc., Osaka (JP)

(72) Inventor: Susumu TANIGUCHI, Osaka-shi (JP)

(73) Assignee: KYOCERA Document Solutions Inc., Osaka (JP)

(21) Appl. No.: 15/090,960

(22) Filed: Apr. 5, 2016

(30) Foreign Application Priority Data
Apr. 6, 2015 (JP) 2015-077758

(51) Int. Cl. G03G 15/00; B65H 5/06; B65H 5/36

(52) U.S. Cl. CPC G03G 15/6529; B65H 5/36; B65H 5/062

(57) ABSTRACT

An image forming apparatus includes a casing, a conveyance unit, an intermediate roller unit, and a guide section. The intermediate roller unit includes an intermediate roller at a facing surface thereof that faces a sheet conveyance path. The conveyance unit includes a conveyance roller at a facing surface thereof that faces the sheet conveyance path. The guide section guides movement of the intermediate roller unit relative to the casing such that the conveyance roller pushes the intermediate roller in association with closing movement of the conveyance unit relative to the casing to close the intermediate roller unit relative to the casing.

### INCORPORATION BY REFERENCE

The present application claims priority under 35 U.S.C. §119 to Japanese Patent Application No. 2015-077758, filed Apr. 6, 2015. The contents of this application are incorporated herein by reference in their entirety.

### BACKGROUND

The present disclosure relates to an image forming apparatus that forms an image on a recording medium (for example, a sheet of paper).

An image forming apparatus includes a main body, a conveyance unit, and an intermediate roller unit. In association with closing movement of the conveyance unit relative to the main body, the intermediate roller unit is closed relative to the main body. When a conveyance guide of the conveyance unit pushes a conveyance guide of the intermediate roller unit in the image forming apparatus, the intermediate roller is closed relative to the main body.

### SUMMARY

An image forming apparatus according to the present disclosure forms an image on a recording medium and includes a main body, an intermediate roller unit, a conveyance unit, and a guide section. The main body includes a first sheet conveyance path that conveys a recording medium and a second sheet conveyance path that conveys the recording medium disposed outward of the first sheet conveyance path. The intermediate roller unit is disposed between the first and second sheet conveyance paths in an openable and closable manner relative to the main body and has a facing surface that faces the first sheet conveyance path and that constitutes a part of a conveyance guide of the first sheet conveyance path and a facing surface that faces the second sheet conveyance path. The conveyance unit is disposed outward of the second sheet conveyance path in an openable and closable manner relative to the main body and has a facing surface that faces the second sheet conveyance path and that constitutes a part of a conveyance guide of the second sheet conveyance path. The guide section guides movement of the intermediate roller unit relative to the main body. The intermediate roller unit includes an intermediate roller disposed on the facing surface of the intermediate roller unit that faces the second sheet conveyance path. The intermediate roller conveys the recording medium to the second sheet conveyance path. The conveyance unit includes a conveyance roller disposed on the facing surface of the conveyance unit that faces the second sheet conveyance path. The conveyance roller forms a conveyance nip region with the intermediate roller. The guide section guide movement of the intermediate roller unit relative to the main body such that the conveyance roller pushes the intermediate roller in association with closing movement of the conveyance unit relative to the main body to close the intermediate roller unit relative to the main body.

### BRIEF DESCRIPTION OF THE DRAWINGS

FIG. 1 is a perspective view illustrating an image forming apparatus according to an embodiment of the present disclosure.

FIG. 2 is a cross sectional view taken along the line II-II in FIG. 1.

FIG. 3 is an enlarged cross sectional view of a main part in FIG. 2.

FIG. 4 is a perspective view illustrating a positional relationship between an intermediate roller unit in an open state and a manual sheet conveyance path.

FIG. 5 is a perspective view illustrating a positional relationship between the intermediate roller unit in a closed state and the manual sheet conveyance path.

FIG. 6 is a perspective view illustrating a guide section disposed on a casing.

FIG. 7 is a perspective view illustrating a positional relationship between the intermediate roller unit in the closed state and the guide section.

FIG. 8 is a perspective view illustrating a positional relationship between the intermediate roller unit in the open state and the guide section.

FIG. 9 is a perspective view illustrating a state in which a conveyance roller is in contact with an intermediate roller in closing movement of the conveyance unit.

FIG. 10 is a cross sectional view illustrating a state in which the conveyance roller is in contact with the intermediate roller in closing movement of the conveyance unit.

### DETAILED DESCRIPTION

Embodiments of the present disclosure will be described below with reference to the accompanying drawings. Note that elements that are the same or equivalent are indicated by the same reference signs in the drawings and description thereof is not repeated.

Configuration

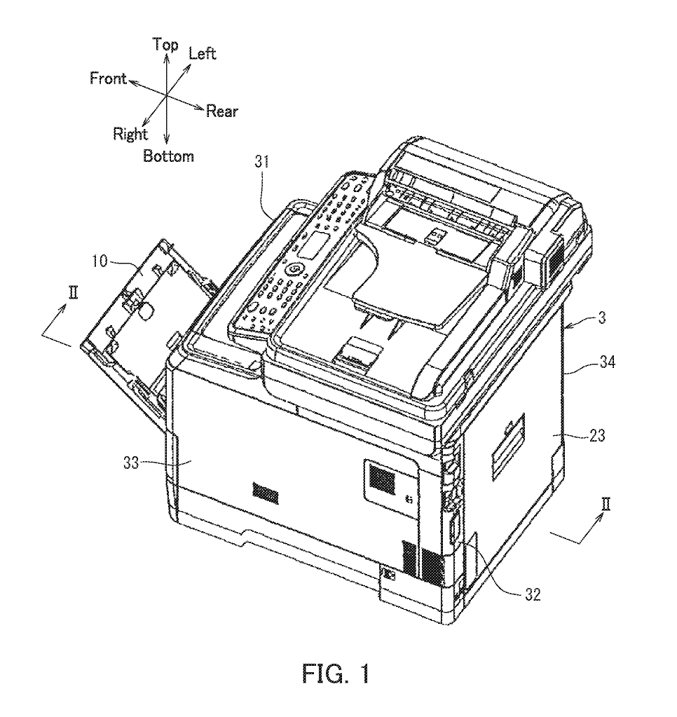

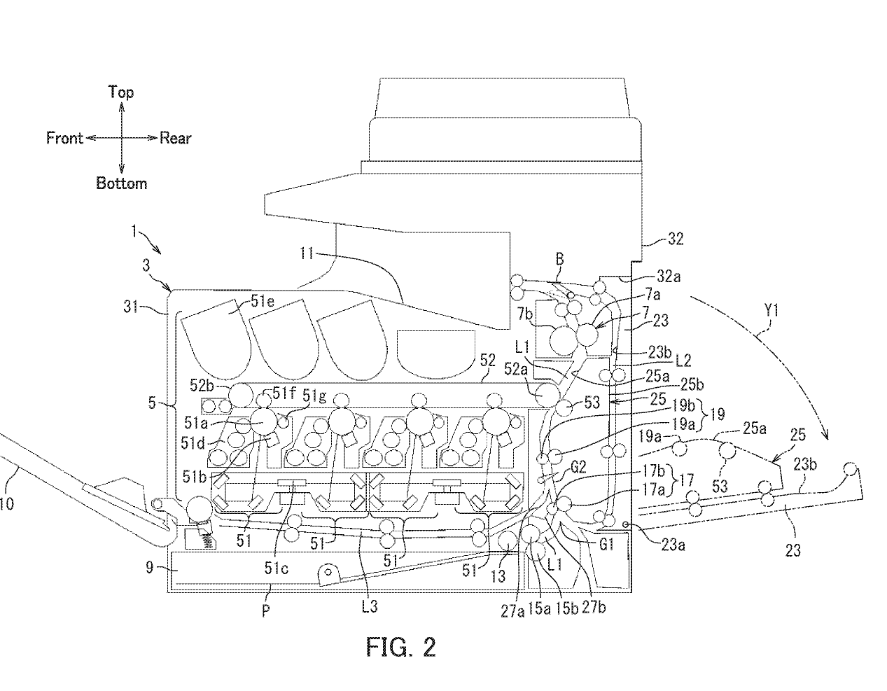

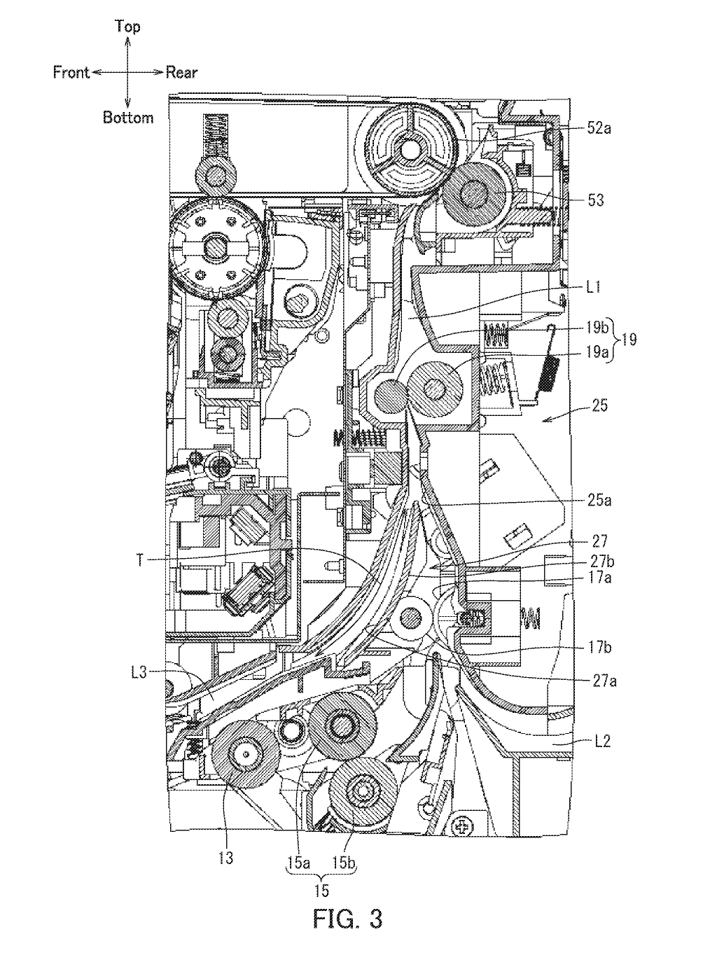

An image forming apparatus 1 according to an embodiment of the present disclosure will be described with reference to FIGS. 1 and 3. FIG. 1 is a perspective view of the image forming apparatus 1 according to an embodiment of the present disclosure. FIG. 2 is a cross sectional view taken along the line II-II in FIG. 1. FIG. 3 is an enlarged cross sectional view of a main part (a part around an intermediate roller unit 27) in FIG. 2.

As illustrated in FIGS. 1-3, the image forming apparatus 1 according to the present embodiment is an apparatus that forms an image on a sheet P and includes a casing (a main body) 3, an image forming section 5, a fixing section 7, a sheet feed cassette 9, a manual feed tray 10, and an exit tray 11. The sheet feed cassette 9 is disposed in a lower part of the casing 3. The image forming section 5 is disposed above the sheet feed cassette 9 in the casing 3. The exit tray 11 is disposed at the top of the casing 3 in an in-body space open at the sides thereof above the image forming section 5. The fixing section 7 is disposed beside the image forming section 5 in the casing 3.

The casing 3 has a box shape with a rectangular bottom surface and four side walls 31, 32, 33, and 34 that are surrounding walls. For the sake of description convenience, the side walls 31, 32, 33, and 34 are defined as follows in the present embodiment: the side wall 31 is a front wall; the side wall 32 opposite to the front wall is a rear wall; the side wall 33 is a right wall; and the side wall 34 is a left wall. Hereinafter, the side walls 31, 32, 33, and 34 may be referred to as the front wall 31, the rear wall 32, the right wall 33, and the left wall 34, respectively.

As illustrated in FIG. 1, the sides of the front wall 31, the rear wall 32, the right wall 33, and the left wall 34 are defined as the front, rear, right, and left sides of the image forming apparatus 1, respectively, in the present embodiment. In terms of the relationship between front, rear, right, and left sides defined as above, the fixing section 7 is disposed on the rear side of the image forming section 5.

The image forming section 5 forms a toner image on a sheet P fed from a sheet feed cassette 9 or a manual feed tray 10, as illustrated in FIG. 2. The image forming section 5 includes image forming units 51, an intermediate transfer belt 52, and a secondary transfer roller 53.

The intermediate transfer belt 52 is an endless belt. The intermediate transfer belt 52 is wound to be supported between a drive roller 52a and a driven roller 52b and is circulated by driving and rotation of the drive roller 52a.

The image forming units 51 correspond to toners in a plurality of colors (for example, cyan, magenta, yellow, and black). The image forming units 51 each form a toner image in a corresponding color on the surface of the intermediate transfer belt 52. The image forming units 51 each include a photosensitive drum 51a, a charger 51b, an exposure device 51c, a developing device 51d, a toner container 51e, a primary transfer roller 51f, and a cleaner 51g.

The photosensitive drum 51a includes a photosensitive layer on a surface thereof. The charger 51b uniformly charges the surface of the photosensitive drum 51a to a predetermined potential. The exposure device 51c irradiates the charged surface of the photosensitive drum 51a with laser light based on image information to form an electrostatic latent image corresponding to the image information on the surface of the photosensitive drum 51a. The toner container 51e supplies toner to the developing device 51d. The developing device 51d develops the electrostatic latent image formed on the surface of the photosensitive drum 51a to form a toner image.

The primary transfer roller 51f transfers the toner image on the surface of the photosensitive drum 51a to the surface of the intermediate transfer belt 52. The primary transfer roller 51f is supported such as to press the photosensitive drum 51a with the intermediate transfer belt 52 therebetween. Primary transfer voltage is applied to the surface of the primary transfer roller 51f. In the above configuration, when the toner image on the surface of the photosensitive drum 51a is pressed against the intermediate transfer belt 52, the toner image on the surface of the photosensitive drum 51a is transferred to the surface of the intermediate transfer belt 52 by electrostatic attraction of the primary transfer roller 51f. The cleaner 51g removes residual toner on the surface of the photosensitive drum 51a after transfer.

Through the above, the image forming units 51 for the respective colors form toner images in the respective colors on the surface of the intermediate transfer belt 52 so as to superpose the tone images. Thus, a color toner image is formed on the surface of the intermediate transfer belt 52. The color toner image is conveyed to the secondary transfer roller 53 by circulation of the intermediate transfer belt 52.

The secondary transfer roller 53 transfers the color toner image on the surface of the intermediate transfer belt 52 to the sheet P. The secondary transfer roller 53 is supported such as to press the drive roller 52a with the intermediate transfer belt 52 therebetween. Secondary transfer voltage is applied to the secondary transfer roller 53. With timing when the color toner image on the intermediate transfer belt 52 passes through a press contact region (a secondary transfer nip region) between the drive roller 52a and the secondary transfer roller 53, the sheet P passes through the press contact region between drive roller 52a and the secondary transfer roller 53. As a result, the color toner image on the intermediate transfer belt 52 is transferred to the sheet P by the secondary transfer voltage applied to the secondary transfer roller 53.

The fixing section 7 fixes the color toner image transferred to the sheet P. The fixing section 7 includes a pressure roller 7a and a fixing roller 7b. The fixing roller 7b includes a heat source to heat the sheet P. The pressure roller 7a is in press contact with the fixing roller 7b. The sheet P to which the color toner image is transferred passes through a press contact region (a fixing nip region) between the pressure roller 7a and the fixing roller 7b. As a result, the color toner image is fixed to the sheet P by heat of the fixing roller 7b. Through the above, an image is formed on the sheet P.

The sheet feed cassette 9 stores therein a plurality of sheets P. The sheets P in the sheet feed cassette 9 pass one at a time through a sheet conveyance path (a second sheet conveyance path) L1, the secondary transfer nip region between the drive roller 52a and the secondary transfer roller 53, and then the fixing nip region between the pressure roller 7a and the fixing roller 7b, and are finally ejected onto the exit tray 11.

The sheet conveyance path L1 extends upward from the sheet feed cassette 9 to the exit tray 11 along the rear wall 32 in the casing 3 via the secondary transfer nip region between the drive roller 52a and the secondary transfer roller 53 and the fixing nip region between the pressure roller 7a and the fixing roller 7b.

A pickup roller 13 is disposed in the vicinity of the sheet feed cassette 9 in the casing 3. A sheet feed roller pair 15, a conveyance roller pair 17, and a registration roller pair 19 are disposed in order from upstream to downstream in terms of a sheet conveyance direction in the sheet conveyance path L1. The sheet feed roller pair 15, the conveyance roller pair 17, and the registration roller pair 19 are disposed between the pickup roller 13 and the secondary transfer roller 53.

The pickup roller 13 picks up one at a time an uppermost sheet out of the sheets P in the sheet feed cassette 9. In a situation in which the pickup roller 13 picks up a plurality of sheets P, the sheet feed roller pair 15 feeds only the uppermost sheet P out of the plurality of sheets P to the conveyance roller pair 17 and returns the other sheet(s) P to the sheet feed cassette 9. The conveyance roller pair 17 conveys the sheet P fed from the sheet feed roller pair 15 to the registration roller pair 19. The registration roller pair 19 controls timing with which the sheet P from the conveyance roller pair 17 is fed to the secondary transfer nip region between the drive roller 52a and the secondary transfer roller 53.

The sheet feed roller pair 15 includes a sheet feed roller 15a and a retard roller 15b. The conveyance roller pair 17 includes a conveyance roller 17a and an intermediate roller 17b. The registration roller pair 19 includes a registration roller 19a and a registration driven roller 19b.

A reversed sheet conveyance path L2 in which the sheet P is turned over is located in the casing 3. As illustrated in FIG. 2, the reversed sheet conveyance path L2 branches off from the sheet conveyance path L1 at a branch point B, passes between the sheet conveyance path L1 and the rear wall 32, and merges with the sheet conveyance path L1 at a confluence point G1. The branch point B is located downstream of the fixing section 7 in the sheet conveyance path L1 in terms of the sheet conveyance direction. The confluence point G1 is located upstream of the conveyance roller pair 17 in the sheet conveyance path L1 in terms of the sheet conveyance direction. In a situation in which an image is to be formed on the back surface of the sheet P, the sheet P having passed through the fixing section 7 is drawn back to be conveyed into the reversed sheet conveyance path L2 through the branch point B, passes through the reversed sheet conveyance path L2, and is returned to the sheet conveyance path L1 from the confluence point G1. As a result, the sheet P is turned over. The reversed sheet P is conveyed in the sheet conveyance path L1. Then, an image is formed on the back surface of the sheet P in a similar manner to that described above.

The manual feed tray 10 feeds a sheet P to the image forming apparatus 1 in a manner different from the manner in which the sheet feed cassette 9 feeds the sheet P. The manual feed tray 10 protrudes outward from a side wall (for example, the front wall 31) of the casing 3. A manual sheet conveyance path (a first sheet conveyance path) L3 extends in the casing 3. The manual sheet conveyance path L3 connects the manual feed tray 10 to the sheet conveyance path L1. The manual sheet conveyance path L3 extends from the manual feed tray 10, passes between the image forming section 5 and the sheet feed cassette 9, and merges with the sheet conveyance path L1 at a confluence point G2 of the sheet conveyance path L1. In the configuration as above, the sheet conveyance path L1 is located behind (outward of) the manual sheet conveyance path L3. The confluence point G2 is located upstream of the registration roller pair 19 in the sheet conveyance path L1 in terms of the sheet conveyance direction. The sheet P having fed from the manual feed tray 10 is conveyed into the sheet conveyance path L1 from the confluence point G2 via the manual sheet conveyance path L3. The sheet P is then conveyed in the sheet conveyance path L1. Subsequently, an image is formed on the sheet P in a similar manner to that described above.

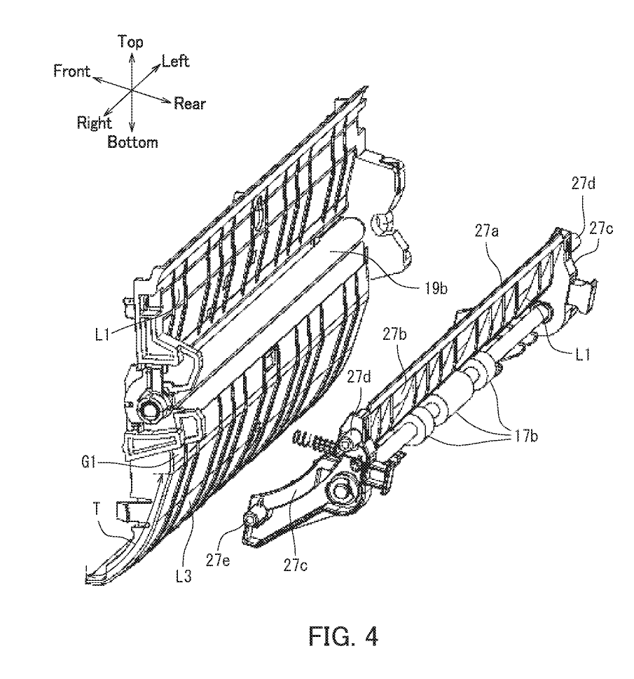

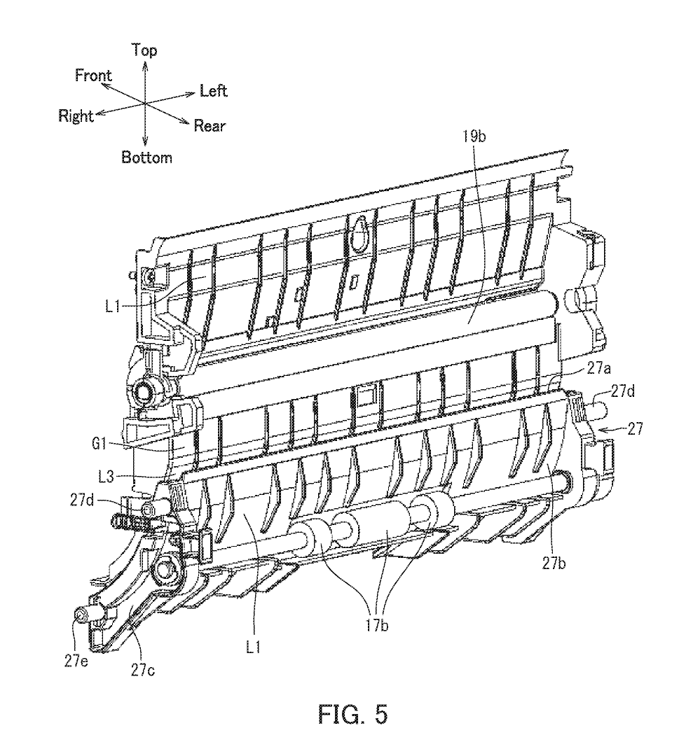

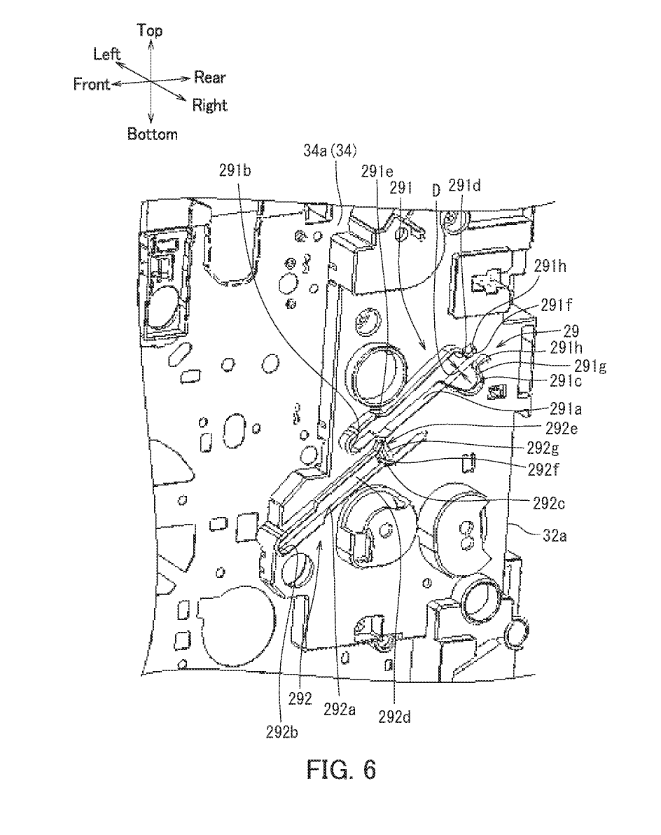

The image forming apparatus 1 further includes a cover 23, a conveyance unit 25, and an intermediate roller unit 27. The following describes the cover 23, the conveyance unit 25, and the intermediate roller unit 27 with reference to FIGS. 4-6 in addition to FIGS. 1-3. FIG. 4 is a perspective view illustrating a positional relationship between the intermediate roller unit 27 in an open state and the manual sheet conveyance path L3. FIG. 5 is a perspective view illustrating a positional relationship between the intermediate roller unit 27 in a closed state and the manual sheet conveyance path L3. FIG. 6 is a perspective view illustrating a guide section 29 disposed on the casing 3.

The cover 23 is disposed on one of the side walls (for example, the rear wall 32) of the casing 3 in an openable and closable manner, as illustrated in FIGS. 1 and 2. Specifically, the rear wall 32 has an opening 32a. The opening 32a is in a rectangular shape, for example. The opening 32a ranges in the rear wall 32 to cover the reversed sheet conveyance path L2. The cover 23 is disposed at the casing 3 so as to open and close the opening 32a of the rear wall 32. In an open state of the cover 23 opening the opening 32a of the rear wall 32, the interior of the casing 3 (for example, the fixing section 7 and the conveyance unit 25) is exposed. In a closed state of the cover 23 closing the opening 32a of the rear wall 32, the cover 23 closes the opening 32a to constitute a part of the rear wall 32.

As illustrated in FIG. 2, pivot shafts 23a are disposed on the respective opposite sides of a lower end part of the cover 23. The pivot shafts 23a are supported by the casing 3 in a rotatable manner. When an upper end part of the cover 23 is turned rearward (outward, in a direction indicated by an arrow Y1 in FIG. 2) about the pivot shafts 23a as pivots, the cover 23 is in the open state.

The cover 23 has an inner surface 23b that constitutes a part of a conveyance guide of the reversed sheet conveyance path L2. The inner surface 23b of the cover 23 faces the reversed sheet conveyance path L2 in the closed state of the cover 23 to function as the conveyance guide of the reversed sheet conveyance path L2.

The conveyance unit 25 is disposed between the sheet conveyance path L1 and the reversed sheet conveyance path L2, as illustrated in FIGS. 2 and 3. In the above configuration, the conveyance unit 25 is located behind (outward of) the sheet conveyance path L1. The conveyance unit 25 is disposed in an openable and closable manner relative to the casing 3. In the present embodiment, the conveyance unit 25 is disposed on the inner surface 23b of the cover 23 and is opened and closed relative to the casing 3 in association with opening and closing of the cover 23.

The conveyance unit 25 has facing surfaces 25a and 25b. The facing surface 25a faces a part of the sheet conveyance path L1. The facing surface 25b faces a part of the reversed sheet conveyance path L2. The facing surface 25a curves along the sheet conveyance path L1 to constitute a part of a conveyance guide of the sheet conveyance path L1. The conveyance roller 17a, the registration roller 19a, and the secondary transfer roller 53 are disposed on the facing surface 25a. The facing surface 25b constitutes a part of the conveyance guide of the reversed sheet conveyance path L2. The intermediate roller 17b that is a partner of the conveyance roller 17a of the conveyance roller pair 17 is disposed at the intermediate roller unit 27. The registration driven roller 19b that is a partner of the registration roller 19a of the registration roller pair 19 and the drive roller 52a that is a partner of the secondary transfer roller 53 are disposed at the casing 3.

The intermediate roller unit 27 is disposed between the sheet conveyance path L1 and the manual sheet conveyance path L3 so as to be openable and closable relative to the casing 3, as illustrated in FIGS. 2 and 3.

As illustrated in FIGS. 4 and 5, the intermediate roller unit 27 has a rectangular plate shape that is long in a left-right direction. The intermediate roller unit 27 has two main surfaces 27a and 27b. One 27a of the main surfaces 27a and 27b faces a part of the manual sheet conveyance path L3, and the other main surface 27b faces a part of the sheet conveyance path L1. Hereinafter, the main surfaces 27a and 27b are referred to as facing surfaces 27a and 27b, respectively. The facing surface 27a curves along the manual sheet conveyance path L3 to constitute a part of a conveyance guide of the manual sheet conveyance path L3. A segment T indicted in FIG. 3 is a segment of the manual sheet conveyance path L3 where the facing surface 27a constitutes the conveyance guide of the manual sheet conveyance path L3. The intermediate roller 17b is disposed on the facing surface 27b.

The intermediate roller unit 27 includes first bosses 27d and second bosses 27e. The first bosses 27d protrude from respective upper end parts in a longitudinal direction of opposite end surfaces 27c of the intermediate roller unit 27 in the left-right direction. The first bosses 27d may be cylindrical, for example. The second bosses 27e protrude from respective lower end parts in the longitudinal direction of the opposite end surfaces 27c of the intermediate roller unit 27. The second bosses 27e may be cylindrical, for example.

As illustrated in FIG. 6, the casing 3 include the guide section 29. The guide section 29 is disposed on the inner surface of each of the right and left side walls 33 and 34. That is, the guide sections 29 are located on the respective inner surfaces of the casing 3 that face the respective opposite end surfaces 27c of the intermediate roller unit 27. Note that FIG. 6 illustrates only a guide section 29 on an inner surface 34a of the left wall 34. The guide sections 29 guide opening and closing movement of the intermediate roller unit 27 relative to the casing 3. The guide sections 29 each include a first guide section 291 and a second guide section 292. The first guide section 291 guides movement of a corresponding one of the first bosses 27d. The second guide section 292 guides movement of a corresponding one of the second bosses 27e.

In the above configuration, the first and second guide sections 291 and 292 independently guide the movement of first and second bosses 27d and 27e, respectively. As a result, the intermediate roller unit 27 can be set in any posture during the first and second guide sections 291 and 292 guiding the movement of the intermediate roller unit 27.

Each of the first guide sections 291 is a guide rail having a guide groove 291a. The first guide section 291 allows the corresponding first boss 27d to move along the guide groove 291a to guide the movement of the first boss 27d. The first guide section 291 has opposite end portions, that is, an inward end portion (first inward end portion) 291b and an outward end portion (first outward end portion) 291c. The inward end portion 291b is located at an end on an “inward side” of the first guide section 291. The outward end portion 291c is located at an end on an “outward side” of the first guide section 291. The term “inward” herein means an inward location relative to the casing 3 within the casing 3. The term “outward” herein means an outward location relative to the casing 3 within the casing 3. In the present embodiment, the term “inward” corresponds to “front” and the term “outward” corresponds to “rear”. The first bosses 27d are located at the respective inward end portions 291b in a closed state of the intermediate roller unit 27 and located at the respective outward end portions 291c in an open state thereof.

The outward end portion 291c of the first guide section 291 is located behind (outward of) and higher than the inward end portion 291b. The first guide section 291 has an apex portion 291d. The apex portion 291d is located between the inward and outward end portions 291b and 291c. The apex portion 291d is located higher than the inward and outward end portions 291b and 291c and closer to the outward end portion 291c than the center between the inward and outward end portions 291b and 291c. That is, a segment (a first segment) between the inward end portion 291b and the apex portion 291d of the first guide section 291 inclines rearwardly upward of the image forming apparatus 1 (that is, obliquely upward toward the conveyance unit 25). A segment (a second segment) between the apex portion 291d and the outward end portion 291c of the first guide section 291 inclines rearwardly downward of the image forming apparatus 1 (that is, obliquely downward toward the conveyance unit 25). These segments may each have a linear shape, for example. A stepped portion 291e is formed in the vicinity of the inward end portion 291b between the apex portion 291d and the inward end portion 291b so as to ascend in a stepwise fashion from the apex portion 291d toward the inward end portion 291b.

The inward and outward end portions 291b and 291c of the first guide section 291 are closed so as to prevent the first boss 27d from falling from the guide groove 291a. The first guide section 291 has an upper wall portion 291g. The upper wall portion 291g is located between the apex portion 291d and the outward end portion 291c. The upper wall portion 291g has an opening 291f. The upper wall portion 291g has two edge portions 291h opposite to each other. The opposite edge portions 291h define the opening 291f. The opposite edge portions 291h extend outward of the upper wall portion 291g. The opening 291f is located between two plate members that constitute the respective opposite edge portions 291h and disposed substantially in parallel to each other. The first boss 27d is put into and taken out from the guide groove 291a through the opening 291f. The opening 291f has an opening length D smaller (for example, slightly smaller) than the diameter of the first boss 27d. The opening length D (a distance between the opposite end portions) is a distance between the plate members that constitute the respective opposite edge portions 291h. When the first boss 27d is press fitted into the opening 291f, the first boss 27d is put into the guide groove 291a. When the first boss 27d is pulled out through the opening 291f, the first boss 27d is pulled out from the guide groove 291a. In the above configuration, a short path having the same width as the opening length D of the opening 291f is formed between the guide groove 291a and the opening 291f. In the above configuration, sufficient pressing force is needed to put the first boss 27d into and take out the first boss 27d from the guide groove 291a through the opening 291f. This can prevent the first boss 27d from falling from the opening 291f.

Each of the second guide sections 292 is a guide rail having a guide groove 292a likewise the first guide sections 291. The second guide section 292 has opposite end portions, that is, an inward end portion (second inward end portion) 292b and an outward end portion (second outward end portion) 292c. The inward end portion 292b is located at an end on an “inward side” of the second guide section 292. The outward end portion 292c is located at an end on an “outward side” of the second guide section 292. The term “inward” herein means an inward location relative to the casing 3 within the casing 3. The term “outward” herein means an outward location relative to the casing 3 within the casing 3. In the present embodiment, the term “inward” corresponds to “front” and the term “outward” corresponds to “rear”. The second bosses 27e are located at the respective inward end portions 292b in the closed state of the intermediate roller unit 27 and located at the respective outward end portions 292c in the open state thereof. The outward end portion 292c is located behind (outward of) and higher than the inward end portion 292b. That is, a segment (a third segment) of the second guide section 292 between the inward and outward end portions 292b and 292c inclines rearwardly upward of the image forming apparatus 1 (that is, obliquely upward toward the conveyance unit 25).

The present embodiment describes an example in which the inward end portion 292b of the second guide section 292 is located frontward (inward of the casing 3) and below the inward end portion 291b of the first guide section 291. In the above configuration, the facing surface 27a of the intermediate roller unit 27 can be located along the segment T of the manual sheet conveyance path L3 in the closed state of the intermediate roller unit 27. Further, the outward end portion 292c of the second guide section 292 is located frontward (inward of the casing 3) and below the outward end portion 291c of the first guide section 291. In the above configuration, the intermediate roller unit 27 can be inclined so that the upper end part of thereof is located rearwardly upward of the image forming apparatus 1.

The segment of the second guide section 292 between the inward and outward end portions 292b and 292c may have a linear shape, for example. The upward angle of the second guide section 292 may be set to be equal to the inclined angle between the inward end portion 291b and the apex portion 291d of the first guide section 291, for example.

The inward end portion 292b of the second guide section 292 is closed, and the outward end portion 292c thereof is open. The second guide section 292 has an engaging protrusion 292e. The engaging protrusion 292e is disposed on a bottom surface 292d of the guide groove 292a of the second guide section 292 to close the open outward end portion 292c. The engaging protrusion 292e is capable of protruding from and being flush with the bottom surface 292d. The engaging protrusion 292e is returned to protrude from the bottom surface 292d by an urging member (not illustrated).

The engaging protrusion 292e has an inward surface 292fperpendicular to the bottom surface 292d of the guide groove 292a. An outward surface 292g of the engaging protrusion 292e inclines toward the inward surface 292f such that a top end of the engaging protrusion 292e is closer to the inward surface 292f than a base end thereof on the outward surface 292g. In the above configuration, when the second boss 27e pushes the outward surface 292g of the engaging protrusion 292e, the engaging protrusion 292e is flushed with the bottom surface 292d. Once the second boss 27e is put into the second guide section 292, the engaging protrusion 292e resiliently return to protrude from the bottom surface 292d. Even when the second boss 27e pushes the inward surface 292f of the engaging protrusion 292e, the engaging protrusion 292e is not flush with the bottom surface 292d. In the above configuration, the second boss 27e can be prevented from falling out from the second guide section 292.

The guide sections 29 on the respective inner surfaces of the right and left side walls 33 and 34 are in mirror symmetry.

The right and left first bosses 27d are fitted in the respective guide grooves 291a of the first guide sections 291 of the right and left side walls 33 and 34, while the right and left second bosses 27e are fitted in the respective guide grooves 292a of the second guide sections 292 on the right and left side walls 33 and 34. In the above configuration, the intermediate roller unit 27 is openable and closable relative to the casing 3.

Movement

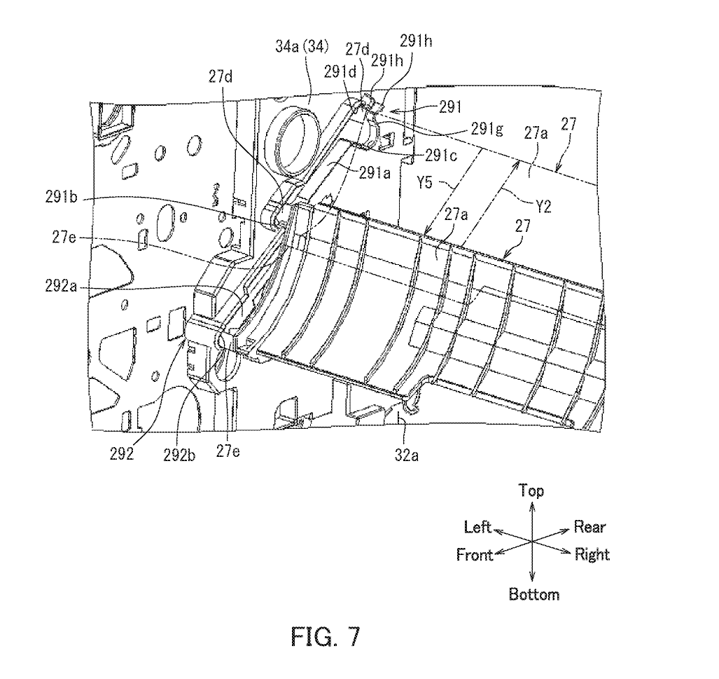

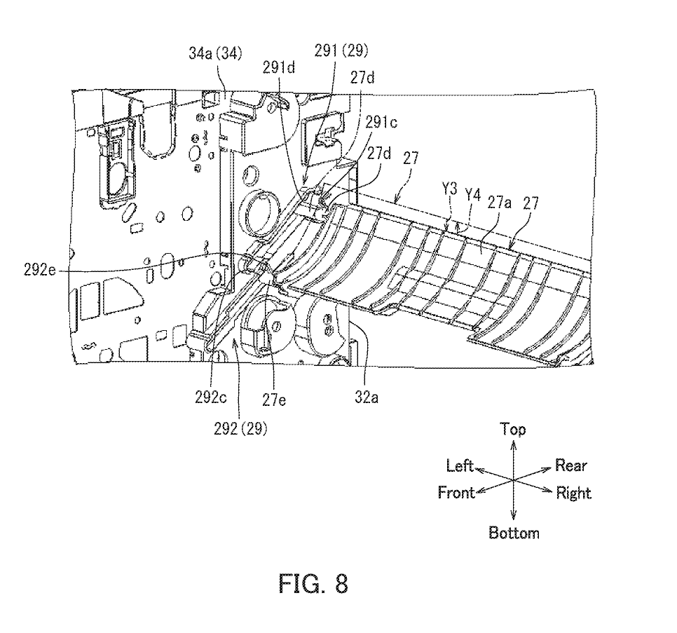

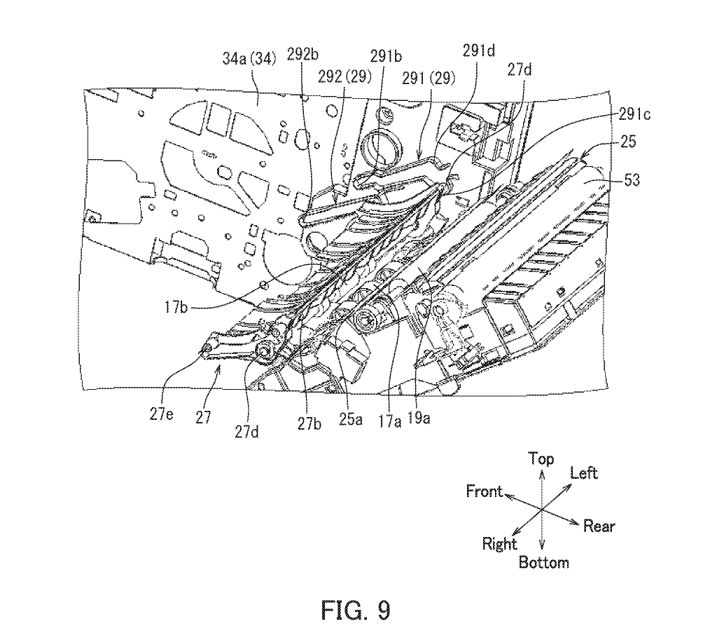

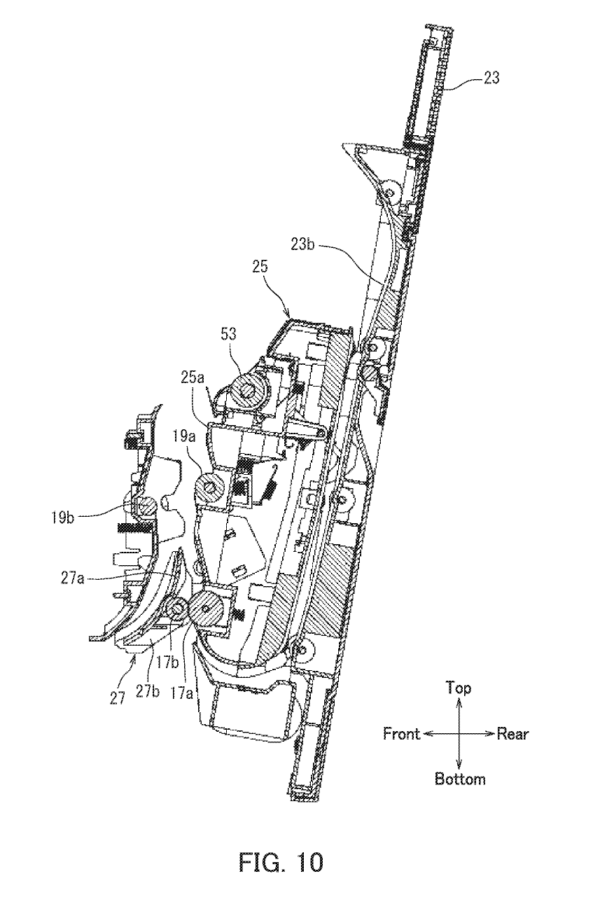

Following describes with reference to FIGS. 3-10, opening and closing movement of the intermediate roller unit 27 relative to the casing 3. FIG. 7 is a perspective view illustrating a positional relationship between the intermediate roller unit 27 in the closed state and the guide section 29. FIG. 8 is a perspective view illustrating a positional relationship between the intermediate roller unit 27 in the open state and the guide section 29. FIG. 9 is a perspective view illustrating a state in which the conveyance roller 17a is in contact with the intermediate roller 17b in closing movement of the conveyance unit 25. FIG. 10 is a cross sectional view illustrating a state in which the conveyance roller 17a is in contact with the intermediate roller 17b in the closing movement of the conveyance unit 25.

In a state in which the intermediate roller unit 27 is closed relative to the casing 3 as illustrated in FIGS. 3 and 5, the first bosses 27d of the intermediate roller unit 27 are located at the respective inward end portions 291b of the first guide sections 291 while the second bosses 27e of the intermediate roller unit 27 are located at the respective inward end portions 292b of the second guide sections 292, as illustrated in FIG. 7. In the above state, as illustrated in FIGS. 3 and 5, the facing surface 27a of the intermediate roller unit 27 faces the manual sheet conveyance path L3 to function as the conveyance guide of the manual sheet conveyance path L3.

In order to open the intermediate roller unit 27 in the closed state (a state in which the intermediate roller unit 27 is closed relative to the casing 3) relative to the casing 3, the conveyance unit 25 is manually opened relative to the casing 3 first in a direction indicated by an arrow Y1 in FIG. 2. Subsequently, the intermediate roller unit 27 is manually pulled rearwardly upward from the casing 3 in a direction indicated by Y2 in FIG. 7. As a result, the respective first bosses 27d are slightly moved from the inward end portions 291b toward the apex portions 291d along the first guide sections 291, slightly moved rearward (outward) in the stepped portions 291e, and then moved to the apex portions 291d. In association therewith, the respective second bosses 27e are moved from the inward end portions 292b toward the outward end portions 292c along the second guide sections 292. Through the above, the intermediate roller unit 27 in the closed state is guided by the first and second guide sections 291 and 292 to be pulled rearwardly upward of the image forming apparatus 1 to the level of the apex portions 291d.

In the above movement, the first bosses 27d are slightly moved rearward (outward) in the respective stepped portions 291e. As a result, the facing surface 27a of the intermediate roller unit 27 is slightly separate from the manual sheet conveyance path L3. This can facilitate rearwardly upward pulling of the intermediate roller unit 27 relative to the image forming apparatus 1.

Subsequently, the upper end of the intermediate roller unit 27 is manually pulled rearwardly downward in a direction indicated by an arrow Y3 in FIG. 8. As a result, the respective first bosses 27d are moved from the apex portions 291d to the outward end portions 291c along the first guide sections 291. As a result, the intermediate roller unit 27 is greatly inclined rearward (outward) such as to be prevented from slipping off into the closed state by its own weight. Through the above, the intermediate roller unit 27 is opened relative to the casing 3.

In the open state, as illustrated in FIG. 4, the facing surface 27a of the intermediate roller unit 27 is separate from the segment T of the manual sheet conveyance path L3 such that the interior of the segment T of the manual sheet conveyance path L3 is exposed. In the above configuration, a jam (a jammed sheet P) in the exposed interior (the segment T) of the manual sheet conveyance path L3 can be removed easily.

After being pulled up to the apex portions 291d, the intermediate roller unit 27 is greatly inclined rearward (outward). As a result, a situation in which the intermediate roller unit 27 blocks an operator's view can be prevented when the operator checks the exposed interior (the segment T) of the manual sheet conveyance path L3.

In order to close the intermediate roller unit 27 relative to the casing 3, the conveyance unit 25 is manually closed relative the casing 3. That is, the cover 23 is manually closed relative to the casing 3. In association with the manual closing, as illustrated in FIGS. 9 and 10, the conveyance roller 17a of the conveyance unit 25 comes in contact with the intermediate roller 17b of the intermediate roller unit 27 to push and move the intermediate roller 17b inward of the casing 3. Hereinafter, a series of movement of the intermediate roller unit 27 in manual closing is referred to as closing movement. In the closing movement, the respective first bosses 27d of the intermediate roller unit 27 are moved from the outward end portions 291c to the apex portions 291d along the respective first guide sections 291 in the direction indicated by an arrow Y4 in FIG. 8. As a result, the intermediate roller unit 27 relatively stands upright.

When the manual closing is further continued, the respective first bosses 27d are moved from the apex portions 291d to the inward end portions 291b along the respective first guide sections 291 in the direction indicated by an arrow Y5 in FIG. 7. In association therewith, the respective second bosses 27e are moved from the outward end portions 292c to the inward end portions 292b along the respective second guide sections 292. As a result, as illustrated in FIG. 3, the intermediate roller unit 27 is closed relative to the casing 3. Through the above, the intermediate roller unit 27 is closed relative to the casing 3 in association with the closing movement of the conveyance unit 25 relative to the casing 3.

In the closed state, the conveyance roller 17a presses the intermediate roller 17b. In the above configuration, the facing surface 27a of the intermediate roller unit 27 is located opposite to the manual sheet conveyance path L3 to function as the conveyance guide of the manual sheet conveyance path L3 and to form the conveyance nip region between the conveyance roller 17a and the intermediate roller 17b.

In the closing movement, only the conveyance roller 17a among respective components of the conveyance unit 25 comes in contact with the intermediate roller 17b and the other components are out of contact with the intermediate roller unit 27. In the above configuration, a situation in which respective resin portions (for example, the conveyance guides) of the conveyance unit 25 and the intermediate roller unit 27 rub to generate sound or are broken can be prevented in the closing movement of the intermediate roller unit 27 relative to the casing 3.

The embodiment of the present disclosure has been described so far with reference to the drawings (FIGS. 1-10). However, the present disclosure is not limited to the above embodiment and a wide range of alterations can be made to the embodiment so long as such alterations do not deviate from the intended scope of the present disclosure (for example, (1) below). The drawings are schematic illustrations that emphasize elements of configuration in order to facilitate understanding thereof. Therefore, thickness, length, the number, etc. of each of the elements in the drawings may differ from actual ones of the elements for the sake of illustration convenience.

Further, the properties of each of the elements, such as material, shape, and dimension thereof described in the above embodiment are mere examples and not limited specifically. The properties of the elements can be modified in various manners within the scope not substantially departing from the advantages of the present disclosure.

(1) In the present embodiment, the shape, length, and inclined angle of the segment between the inward end portion 291b and the apex portion 291d of each of first guide sections 291 are not limited specifically so long as only the conveyance roller 17a among the respective components of the conveyance unit 25 comes in contact with the intermediate roller 17b and the other components are out of contact with the intermediate roller unit 27 during the closing movement. The shape, length, and inclined angle of the segment between the apex portion 291d and the outward end portion 291c of each of the first guide section 291 are also not limited specifically. The same is applied to the shape, length, and inclined angle of the segment between the inward end portion 292b and the outward end portion 292c of each of the second guide sections 292.

What is claimed is:

1. An image forming apparatus that forms an image on a recording medium, comprising:
a main body including a first sheet conveyance path that conveys a recording medium and a second sheet conveyance path that conveys the recording medium, the second sheet conveyance path being disposed outward of the first sheet conveyance path;
an intermediate roller unit disposed between the first and second sheet conveyance paths in an openable and closable manner relative to the main body and having a facing surface that faces the first sheet conveyance path and that constitutes a part of a conveyance guide of the first sheet conveyance path and a facing surface that faces the second sheet conveyance path;
a conveyance unit disposed outward of the second sheet conveyance path in an openable and closable manner relative to the main body and having a facing surface that faces the second sheet conveyance path and that constitutes a part of a conveyance guide of the second sheet conveyance path; and
a guide section configured to guide movement of the intermediate roller unit relative to the main body, wherein
the intermediate roller unit includes an intermediate roller disposed on the facing surface of the intermediate roller unit that faces the second sheet conveyance path, the intermediate roller being configured to convey the recording medium to the second sheet conveyance path,
the conveyance unit includes a conveyance roller disposed on the facing surface of the conveyance unit that faces the second sheet conveyance path, the conveyance roller forming a conveyance nip region with the intermediate roller, and
the guide section guides movement of the intermediate roller unit relative to the main body such that the conveyance roller pushes the intermediate roller in association with closing movement of the conveyance unit relative to the main body to close the intermediate roller unit relative to the main body.

2. The image forming apparatus according to claim 1, wherein
the intermediate roller unit includes first bosses that protrude from respective upper end parts of opposite end surfaces of the intermediate roller unit in a direction perpendicular to a sheet conveyance direction and second bosses that protrude from respective lower end parts of the opposite end surfaces thereof, and
the guide section includes first guide sections and second guide sections at respective opposite inner surfaces of the main body that face the respective opposite end surfaces of the intermediate roller unit, the first guide sections guiding movement of the respective first bosses, the second guide sections guiding movement of the respective second bosses.

3. The image forming apparatus according to claim 2, wherein
the first guide sections each include:
a first inward end portion, a corresponding one of the first bosses being located at the first inward end portion in a closed state of the intermediate roller unit;
a first outward end portion located outward of and higher than the first inward end portion, a corresponding one of the first bosses being located at the first outward end portion in an open state of the intermediate roller unit; and
an apex portion located between the first inward end portion and the first outward end portion and higher than the first inward end portion and the first outward end portion, and
the second guide section each include:
a second inward end portion, a corresponding one of the second bosses being located at the second inward end portion in the closed state of the intermediate roller unit; and
a second outward end portion located outward of the second inward end portion, a corresponding one of the second bosses being located at the second outward end portion in the open state of the intermediate roller unit.

4. The image forming apparatus according to claim 3, wherein
the first guide section includes a stepped portion ascending from the apex portion toward the first inward end portion in a stepwise fashion, the stepped portion being located in the vicinity of the first inward end portion between the apex portion and the inward end portion.

5. The image forming apparatus according to claim 3, wherein
the first guide sections each are a guide rail having a guide groove to guide movement of the first boss, and
the first guide sections each have an upper wall portion between the apex portion and the first outward end portion, the upper wall portion having an opening,
the upper wall portion having edge portions located opposite to each other and defining the opening,
a distance between the edge portions is smaller than a diameter of the first bosses.

6. The image forming apparatus according to claim 3, wherein
the second guide sections each are a guide rail having a guide groove to guide movement of the second boss,
the second outward end portion of each of the second guide sections is open,
an engaging protrusion configured to close the second outward end portion protrudes from a bottom surface of the guide groove of a corresponding one of the second guide sections, and
the engaging protrusion is capable of protruding from and being flush with the bottom surface of the guide groove and spontaneously returning to protrude from the bottom surface of the guide groove.

7. The image forming apparatus according to claim 3, wherein
the first guide sections each have a first segment between the first inward end portion and the apex portion and a second segment between the apex portion and the first outward end portion, the first segment inclining obliquely upward toward the conveyance unit, the second segment inclining obliquely downward toward the conveyance unit.

8. The image forming apparatus according to claim 7, wherein
the first and second segments lie linearly.

9. The image forming apparatus according to claim 5, wherein
the edge portions of the upper wall portion extend outward of the upper wall portion,
the guide groove and the opening of the first guide section shape a path, and
the path has a width substantially equal to the distance between the edge portions of the upper wall portion.

10. The image forming apparatus according to claim 3, wherein
the second guide sections each have a third segment between a corresponding one of the second inward end portions and a corresponding one of the second outward end portions of the second guide sections, the third segment inclining obliquely upward toward the conveyance unit.

11. The image forming apparatus according to claim 10, wherein
the third segment lies linearly.

12. The image forming apparatus according to claim 3, wherein
the second inward end portions of the respective second guide sections are located below and inward of the first inward end portions of the respective first guide sections in the main body.

13. The image forming apparatus according to claim 3, wherein
the second outward end portions of the respective second guide sections are located below and inward of the first outward end portions of the respective first guide sections in the main body.

14. The image forming apparatus according to claim 3, wherein
the second guide sections each have an upward angle that is a same as an inclined angle of a segment of each of the first guide sections between the first inward end portion and the apex portion.

15. The image forming apparatus according to claim 6, wherein
the engaging protrusion has an inward surface and an outward surface,
the inward surface is perpendicular to the bottom surface of the guide groove, and
the outward surface inclines toward the inward surface such that a top end of the engaging protrusion is closer to the inward surface than a base end of the engaging protrusion on the outward surface.
